(19) United States
(12) Patent Application Publication
(10) Pub. No.: US 2016/0093332 A1
(43) Pub. Date: Mar. 31, 2016

(54) AUTOMATED CREATION OF PHOTOBOOKS INCLUDING STATIC PICTORIAL DISPLAYS SERVING AS LINKS TO ASSOCIATED VIDEO CONTENT

(71) Applicant: ZOOMIN USA INC., Philadelphia, PA (US)

(72) Inventor: Sunny B. Rao, Philadelphia, PA (US)

(73) Assignee: ZOOMIN USA INC., Philadelphia, PA (US)

(21) Appl. No.: 14/865,950

(22) Filed: Sep. 25, 2015

Related U.S. Application Data
(60) Provisional application No. 62/055,005, filed on Sep. 25, 2014.

(51) Int. Cl. G11B 27/034; H04N 1/00

(52) U.S. Cl. CPC G11B 27/034; H04N 1/00278; H04N 1/00225; H04N 1/00233

(57) ABSTRACT

An image processing system (IPS) is provided for creating a video-linked photobook. The method includes: receiving a video file including video content; processing the video file to identify a series of still image frames extracted from the video content; formatting the series of still image frames into a pictorial compilation; storing in a memory the pictorial compilation, and an association between the pictorial compilation and the video file; and transmitting from the image processing system computer-readable instructions for printing the pictorial compilation. Accordingly, images excerpted from a video file can be used to create a printed pictorial compilation. Imaging of the pictorial compilation with a smartphone/tablet PC can responsively result in display of the associated video file on the smartphone/tablet PC.

### CROSS-REFERENCE TO RELATED APPLICATION

This application claims the benefit of priority under 35 U.S.C. §119(e) of U.S. Provisional Patent Application No. 62/055,005, filed Sep. 25, 2014, the entire disclosure of which is hereby incorporated herein by reference.

### FIELD OF THE INVENTION

The present invention relates generally to the field of computer systems, and more particularly to a computerized system and method for processing digital videos, and to create a static pictorial compilation representative of the video, to print the static pictorial compilation in printed matter, such as a photobook, and to provide a system for using the static pictorial compilation to provide access, via a communications network, to the associated video, e.g., to cause display of the video on a smartphone, tablet computer, PC, or the like.

### BACKGROUND

The proliferation of digital cameras, tablet computers, and smartphones or other phones (e.g. camera phones) including digital cameras, has resulted in the capturing of numerous digital images. Many of these digital images are in the nature of videos images. By way of example, virtually all smartphones and tablet PCs currently have the ability to capture videos, as well as still images/photographs. With this increase in the sheer volume of digital images (both videographic and still images), it has become increasingly difficult to manage, display and enjoy digital images in a meaningful fashion.

One popular way of displaying and enjoying captured images involves selection of still photographic images, and arrangement of such photographic images into an electronic or physical (printed) compilation, which is often printed and/or bound to create a photobook including one or more pages of images. Various commercial services exist that provide a native-app based and/or web-based graphical user interfaces for manually reviewing, selecting and creating a photobook.

Videos, by their very nature, are not readily reproducible in printed form, and thus are not includable in printed photobooks. Some printed materials have been created that include a reference or a link to video content, e.g., using a QR code or bar code. These references or links may include human-readable text, or a special-purpose machine-readable image that is decodable to provide a link usable by a web browser, etc. to access a stored video via a communications network. Such URLs and QR/bar codes serving as links are generally solely or primarily utilitarian in nature, and they are not intended to have aesthetic appeal. Accordingly, they are generally undesirable for inclusion in a photobook, which is intended to provide an attractive and aesthetically appeal presentation of digital/photographic images. Further, these traditional links/codes/references are, as far as a human observed can discern, wholly unrelated in appearance to any of the images or content of the video they represent, and of the information likely to be included in a photobook. Accordingly, such traditional links/codes/references are/would be “out of place” in a photobook intended to have aesthetic appeal. As a result, such traditional links/codes/references are not often included in photobooks, and video content is not often linked to printed photobooks.

What is needed is an improved system and method for linking video content to photobooks, particularly printed photobooks.

### SUMMARY

The present invention provides an improved system and method for linking video content to photobooks, particularly printed photobooks, and other objects.

According to one aspect, the present invention provides an image processing system (IPS). The IPS includes: processor; a memory operatively connected to the processor for data communication therewith; instructions stored in the memory and executable by the processor to provide a communications engine for transmitting data via a communications network; instructions stored in the memory and executable by the processor to provide a video processing engine configured for capturing a set of still images from a video; instructions stored in the memory and executable by the processor to provide a compilation creation engine configured for creating a pictorial compilation including the set of still images extracted from the video; and instructions stored in the memory and executable by the processor to provide a video retrieval engine configured for identifying a pictorial compilation, identifying a corresponding video associated with the pictorial compilation, and causing the corresponding video to be transmitted to a user, in response to the user's imaging of the pictorial compilation with the user's computerized imaging device.

According to another aspect, the present invention provides a computer-implemented method for creating a video-linked photobook. The method comprises: providing a microprocessor-driven image processing system comprising a video processing engine; receiving at the image processing system a video file including video content; the video processing engine processing the video file to identify a series of still image frames extracted from the video content; the video processing engine formatting the series of still image frames into a pictorial compilation; storing in a memory the pictorial compilation, and an association between the pictorial compilation and the video file; and transmitting from the image processing system computer-readable instructions for printing the pictorial compilation.

Accordingly, images excerpted from a video file can be used to create a pictorial compilation printed or otherwise displayed in a photobook or in another context, and that pictorial compilation acts as a link for retrieval of the associated video file. More specifically, imaging of the static pictorial compilation, e.g., with a digital camera, is used to create an image that can be matched to the pictorial compilation, and thus to the associate video file. Accordingly, imaging of the static pictorial compilation can responsively result in retrieval and viewing of the associated video file, e.g., the video file from which images in the pictorial compilation have been excerpted. Accordingly, for example, a pictorial compilation in a photobook that shows images from a girl's 9th birthday party can be imaged/photographed and result in display on the imaging computing device a video recording of a family singing a birthday wishes song on that girl's 9th birthday.

### BRIEF DESCRIPTION OF THE FIGURES

An understanding of the following description will be facilitated by reference to the attached drawings, in which:

FIG. 1 is a diagram showing an exemplary networked computing environment including an image processing system in accordance with an exemplary embodiment of the present invention;

FIG. 2 is a flow diagram illustrating a method for automated creation of photobooks including static pictorial displays serving as links to associated video content, in accordance with an exemplary embodiment of the present invention;

FIG. 3 is a flow diagram illustrating a method for time-based processing of a video file to identify a series of frames, in accordance with an exemplary embodiment of the present invention;

FIG. 4 is a flow diagram illustrating a method for image-based processing of a video file to identify a series of frames, in accordance with an alternative exemplary embodiment of the present invention;

FIG. 5 is a flow diagram illustrating a method for formatting a series of frames into a pictorial compilation including a visual marker, in accordance with an exemplary embodiment of the present invention;

FIGS. 6A, 6B and 6C show exemplary alternative pictorial compilations in accordance with exemplary embodiments of the present invention;

FIGS. 7A and 7B show an exemplary photobook including an exemplary pictorial compilation in accordance with an exemplary embodiment of the present invention;

FIG. 8 shows an exemplary pictorial compilation being imaged/scanned by an exemplary smartphone, in accordance with an exemplary embodiment of the present invention;

FIG. 9 shows the exemplary smartphone of FIG. 7 displaying a portion of the video associated with the pictorial compilation shown in FIG. 7; and

FIG. 10 is a schematic diagram showing an exemplary image processing system in accordance with an exemplary embodiment of the present invention.

### DETAILED DESCRIPTION

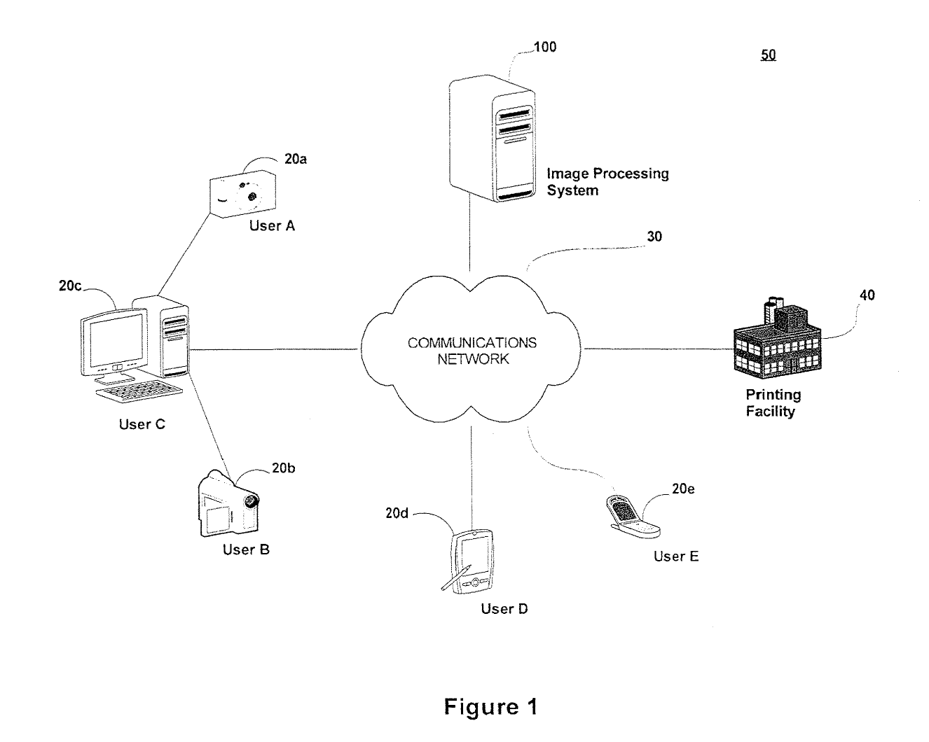

For illustrative purposes, an exemplary embodiment of the present invention is discussed below with reference to FIGS. 1-10. FIG. 1 is a schematic diagram showing an exemplary networked computing environment 50 including an image processing system 100 in accordance with an exemplary embodiment of the present invention.

As shown in FIG. 1, the networked computing environment 50 further includes computing devices operated by individual users such as a digital still camera 20a, a digital video-camera 20b, a personal computer 20c, a smartphone or tablet computer with still/video camera capability 20d, and a cellular camera phone 20e. These computing devices are conventional, commercially-available devices that are generally capable of capturing, storing and/or transmitting digital images, particularly video and/or still photographic images. As known in the art, computing devices 20a, 20b, may be operable to communicate directly with personal computer 20c. Devices 20c, 20d, and 20e are capable of communication via the communications network with the IPS 100, e.g., to communicate captured digital images. Computer hardware and software for enabling such communication is well known in the art and beyond the scope of the present invention, and thus are not discussed in detail herein.

Referring again to the exemplary embodiment of FIG. 1, the networked computing environment 50 further includes a printing facility 40, which is shown diagrammatically for ease of illustration. The printing facility 40 is responsible for production of the photobook or other articles including the pictorial compilation prepared by the IPS 100. The printing facility 40 may include generally conventional printing equipment of a type suitable for printing/binding/producing photobooks, and generally conventional computing devices, e.g., for communication with IPS 100 via network 30, as well known in the art. Computer hardware and software, and other equipment, for enabling operation of the exemplary printing facility 40 are well known in the art and beyond the scope of the present invention, and thus are not discussed in detail herein.

As referenced above and as described in further detail below, the IPS 100 receives digital images (video and/or still photographic images) from one or more of the computing devices 20a-20e, and processes the video in accordance with the present invention.

Optionally, the IPS may further process and/or manipulate still images to allow for design and/or arrangement of a photobook. Further, the IPS may enable transmission or display of the photobook for online or other viewing purposes, and/or enable transmission of the compilation and/or photobook printing data/instructions to the printing facility 40 to cause production of a printed photobook.

In accordance with the present invention, digital images captured and/or stored by one of the devices 20a-20e are received and processed by the IPS 100. In one embodiment, the device processes a video to identify/extract selected still frames from the video, and sends only the extracted still frames to the IPS. In another embodiment, the IPS 100 receives and processes a video to identify/extract selected still frames from the video, creates a pictorial compilation including the still frames, and then creates an association between the compilation and the video content, so that the compilation can be printed in a photobook, and subsequently can be scanned/imaged by a camera of a smartphone/tablet computer, etc., such that the compilation serves as a link for retrieval via a communications network and/or display of the associated video content via the smartphone/tablet, e.g., from the IPS 100 or another network-accessible repository where the video content is stored. In this manner, the user's experience is such that the user can browse a photobook containing photograph images, recognize from the pictorial compilation that an associate video exists, and then retrieve and view the associate video content by scanning/capturing/snapping/imaging compilation using a camera of a web/internet-enabled smartphone or tablet computer, to initiate retrieval of the associated video content from a web server or other storage repository accessible via the network/internet. Accordingly, the system creates a pictorial compilation using still frames extracted from the video, causes printing of the pictorial compilation in a printed photobook, and causes the pictorial compilation to serve as a link, somewhat analogous to a hyperlink, for retrieval of network accessible content—namely, the video from which the frames were extracted. In this manner, the pictorial compilation also serves as a summary, synopsis, or preview of the entirety of the video to which it is a link. Further, the pictorial compilation is human-readable, or human-friendly, in that it includes photographic/still images excerpted from the video, and is not merely a machine-readable encoding of data, and is thus aesthetically pleasing, and/or is not “out-of-place” in a photobook, book, or other printed material including other photographic images.

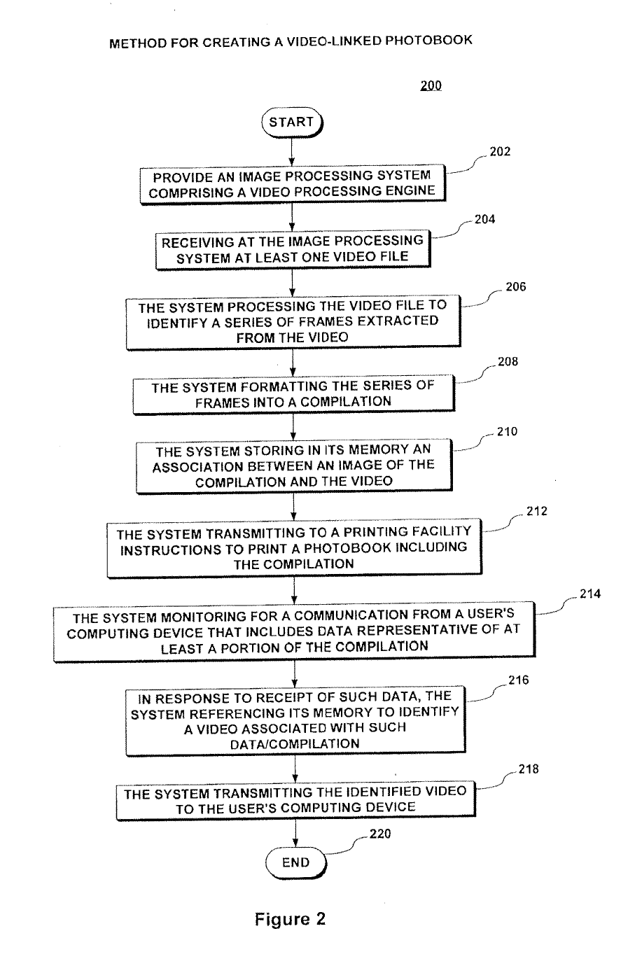

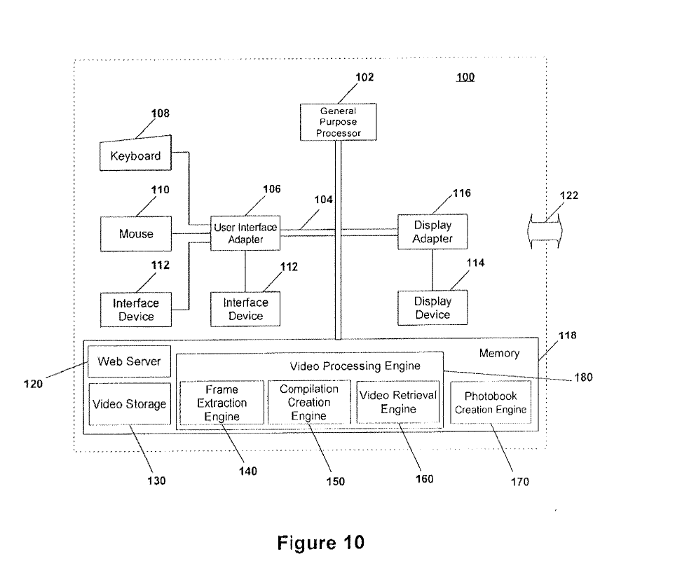

An exemplary method for creating a video-linked photobook in accordance with the present invention is discussed below in greater detail with reference to FIGS. 2-6B. Referring now to the exemplary flow diagram 200 of FIG. 2, an exemplary method begins with providing an image processing system including a video processing engine 180 in accordance with the present invention, as shown at step 202. In this embodiment, the image processing system is provided as a server, such as a web server, configured to provide processing of uploaded digital images in accordance with the present invention. Accordingly, in this embodiment, the image processing system is shown as IPS 100 in exemplary network 50 of FIG. 1. It will be appreciated however, that in other embodiments, the image processing system may be implemented via software running on a client computing device such as devices 20c-20e, e.g., via a smartphone or tablet computer software application. The IPS 100 may include conventional computing hardware and software typical of a commercially-available web server, but is specially-configured to further include software and/or other instructions configuring the IPS 100 to operate in accordance with the present invention, as discussed in greater detail below, particularly with reference to FIG. 10.

In accordance with the present invention, the exemplary IPS 100 includes a video processing engine 180 that has multiple logical components, as shown in FIG. 10. First, the video processing engine (VPE) 180 includes software/instructions providing a frame extraction engine 140 for selecting and/or capturing and/or extracting a set of still images from a video being processed by the IPS 100. Second, the VPE 180 includes software/instructions providing a compilation creation engine 150 for creating a pictorial compilation including the still images extracted from the video. Third, the VPE 180 includes software/instructions providing a video retrieval engine 160—e.g., to allow for recognition of a compilation and/or receipt of information identifying a compilation, and subsequently identifying the video associated with the compilation and causing the associated video to be retrieved from video storage 130 and transmitted to a user, in response to the user's scanning/imaging/capturing of the pictorial compilation with the user's computing device, e.g., as displayed in a printed photobook. Additional detail is provided below, particularly with reference to FIG. 10.

Referring again to FIG. 2, the method further includes receiving at the IPS 100 at least one video file. For example, the video file may be a conventional video file of a type created when capturing video with a conventional smartphone or tablet computer, such as an Apple iPhone, Apple iPad, Apple iPod or other iOS, Android, or other mobile devices. Accordingly, the video file may be in any format supported by the mobile device and/or its operating system. In the exemplary context of iOS, an application on the mobile device may use available iOS APIs to process any video format supported by iOS. By way of example, the video may have a running length/duration of three minutes, and may depict a child listening to family members singing “Happy Birthday,” and then blowing out candles on a birthday cake.

The system then processes the video file to identify and capture/extract a series of frames from the video, as shown at step 206 of FIG. 2. This capture/extraction of frames from the original video may be performed in any suitable fashion, many of which are known in the art. Preferably, the extracted frames generally serve as a summary, synopsis, or preview of the entirety of the video from which the frames are extracted.

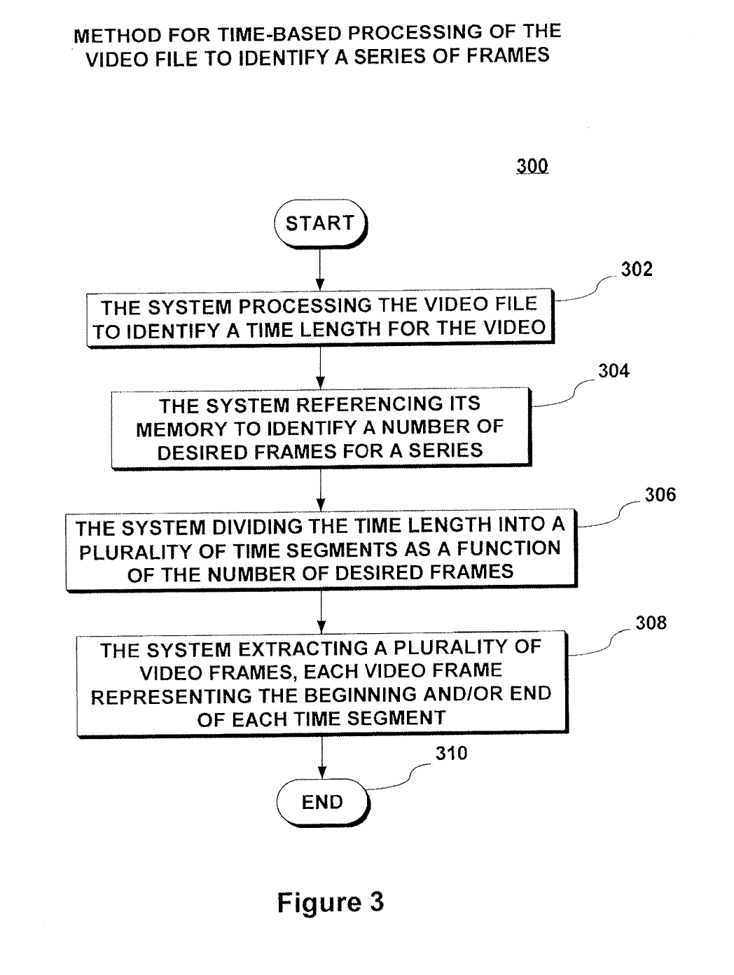

FIG. 3 is a flow diagram 300 illustrating one exemplary method for selecting/capturing frames from a video. This exemplary method provides for time-based processing of the video file to identify a series of multiple frames. This method begins with the IPS 100 (particularly the frame extraction engine 140) processing the subject video file to identify a time length for the video, as shown at step 302. As discussed above, the exemplary video discussed herein is three (3) minutes in length. The system (frame extraction engine 140) then references its memory to identify a number of desired frames for the series to be created, as shown at step 304. The number may be stored, for example, as a default setting within the frame extraction engine 140 in the memory 118. Alternatively, for example, the frame extraction engine 140 may solicit input from a user, and user the provided input as the relevant number. For example, it may be determined that six (6) frames are desired. Next, the system divides the time length into a plurality of time segments as a function of the desired number of frames, as shown at 306. For example, the system may divide the length into 6 equal segments that in this example are each thirty (30) seconds in length. The system 100 then extracts a plurality of video frames, each of which represents the beginning and/or end of each time segment, and this exemplary method ends, as shown at 308 and 310. Accordingly, for example, this may involve capturing a first image at the 30 second mark within the video, a second image at 1 minute, a third image at 1 minute and 30 seconds, a fourth image at 2 minutes, a fifth image at 2 minutes and 30 seconds, and a third image at 3 minutes. In this way, each still frame resembles a still photographic image, and the series of frames are spaced throughout the duration of the video, and thus as a group represent and/or approximate in pictorial fashion the entirety of the video. Alternatively, other suitable intervals, equal or unequal, or any other suitable methodology may be used to select and extract a series of frames.

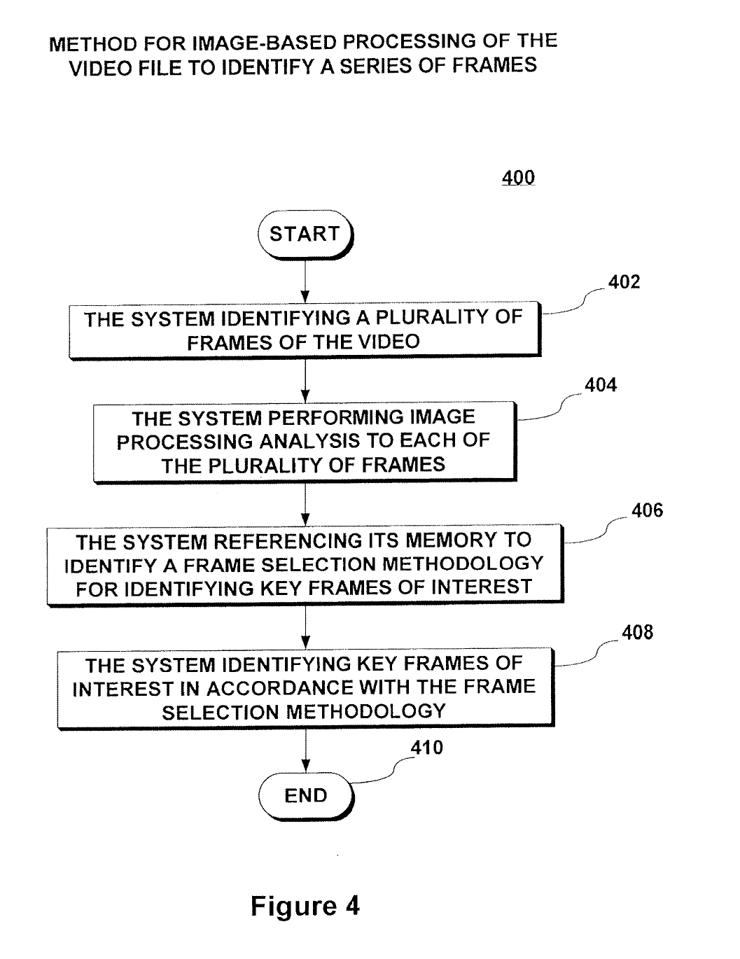

It will be appreciated that although in many cases the time-based selection of frames will yield satisfactory results, there are certain limitations to this approach. For example, the relevant action of content may appear clustered within only a portion of the video. Further, portions of the video may be poor in quality—e.g., due to inadequate lighting, poor focus, etc. In the time-based selection described, the content and quality are essentially ignore in selecting frames. FIG. 4 is a flow diagram 400 illustrating an exemplary alternative method for selecting/capturing frames from a video that overcomes these limitations by selecting/capturing frames as a function of image processing results. This exemplary method provides for image-based processing of the video file to identify a series of multiple frames. This exemplary method begins with the IPS 100 (particularly the frame extraction engine 140) processing the subject video file to identifying a plurality of frames for processing, as shown at step 402. For example, this may be all frames, or a relatively large number of frames selected at short interval—e.g., at 10 second, 5 second, or 1 second intervals. The system (frame extraction engine 140) then performs image processing analysis on each of the plurality of frames, as shown at step 404. The image processing may be performed using conventional software for achieving any desired objective. By way of example, the processing may be performed using content-based image retrieval (CBIR) techniques, image processing techniques allow for detection of substantial changes in the images, image processing techniques providing for face detection, focus quality, lighting, or overall image quality, etc. Any suitable conventional image processing techniques can be used consistent with the teachings of the present invention. The IPS 100 then references its memory 118 (e.g., which may be stored as part of default settings for the frame extraction engine 140) to identify a frame selection methodology for identifying key frames of interest, as shown at step 406. The system then identifies the key frames of interest in accordance with the frame selection methodology, and this exemplary method ends, as shown at steps 408 and 410. By way of example, images having poor image quality may be rejected, so that the desired number of highest-quality images are selected, and/or images having disparate/dissimilar subjects/content may be selected, etc. Again, each still frame resembles a still photographic image, and are frames selected so that as a group they represent and/or approximate in pictorial fashion the entirety of the video. Any other suitable methodology may be used to select and extract a series of frames.

Referring again to FIG. 2, after the system 100 has identified and extracted a series of frames from the video in step 206. The system then formats the series of frames into compilation, as shown at step 208 of FIG. 2. This may be performed by the compilation creation engine 150 of FIG. 10. Essentially, this steps involves arranging the individual frames into a unitary whole. Typically, this involves arranging the images in a juxtaposed fashion, in the order of their appearance within the video, i.e., according to the relative order in the video. This may be determined by times/timestamps associated with the extracted frames, as will be appreciated by those skilled in the art.

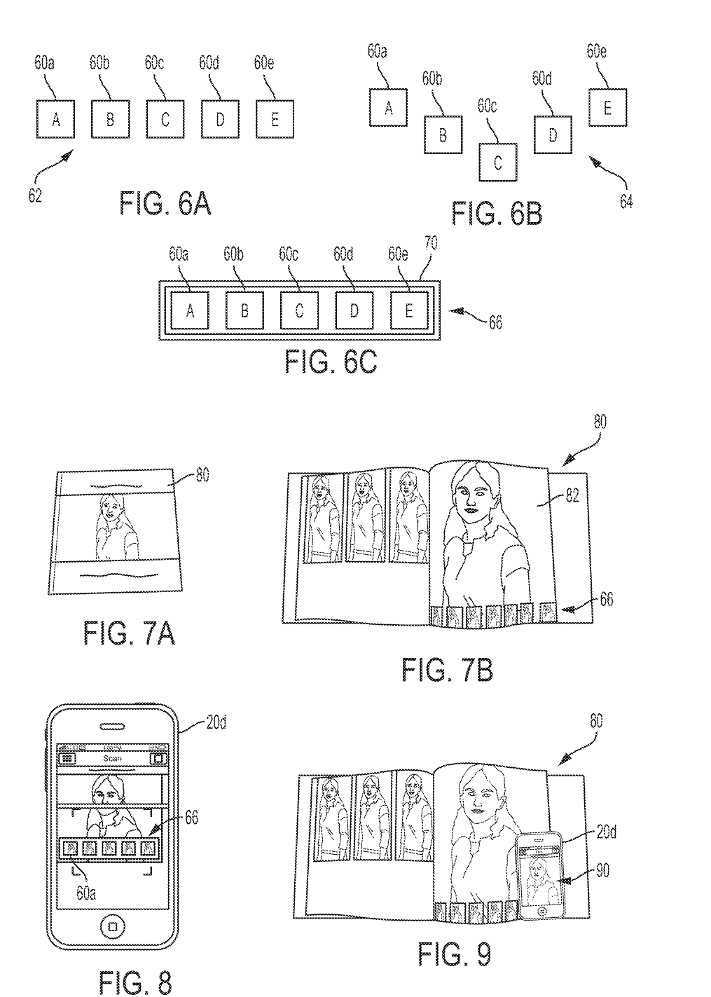

The compilation may have any suitable form. In one example, exemplary frames 60a, 60b, 60c, 60d, 60e may be arranged in a linear array, as shown in the compilation 62 of FIG. 6A, with the images occurring within the video from earliest to latest as viewed from left to right. By way of alternative example, exemplary frames 60a, 60b, 60c, 60d, 60e may be arranged in a non-linear array, as shown in the compilation 64 of FIG. 6B, with the images occurring within the video from earliest to latest as viewed from left to right.

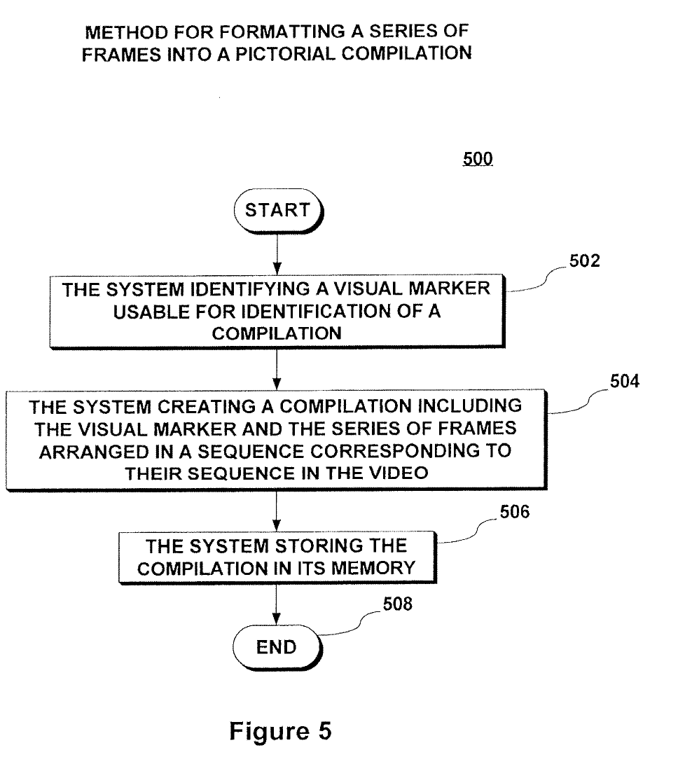

In a certain embodiment, the compilation is created to include a visual marker. FIG. 5 shows a flow diagram 500 illustrating an exemplary method for formatting a series of frames into a pictorial compilation that includes a visual marker. Referring now to FIG. 5, the method begins with the system (particularly, the compilation creation engine 150 of FIG. 10) identifying a visual marker usable for identification of a compilation, as shown at step 502. By way of example, the visual marker may be essentially static, or include a static element, and may be stored as a default image within the compilation creation engine. By way of example, the visual marker may include an image usable by the compilation creation engine 150.

Referring again to FIG. 5, the system 100 next creates a compilation including the visual marker and the series of frames arranged in a sequence corresponding to their sequence in the video, as shown at step 504. By way of example, FIG. 6C shows an exemplary pictorial compilation 66 including key frames 60a, 60b, 60c, 60d, 60e, arranged within a border, created by the compilation creation engine 150 using the default image, that serves as the visual marker 70. By way of example, an image may be used, for example, such that the border in combination with the key frames resembles a film strip, or movie film, or such that it includes a border resembling sprockets, or gears, or a scalloped edge resembling that of a postage stamp, etc. The purpose of the visual marker 70 is to serve as a visual anchor for identifying the images/area to be processed for the purpose of determining compilation information and identifying a linked video. The system then stores the compilation 66, or at least an identifying portion thereof, or identifying information relating thereto, in its memory 118 for future reference, as discussed below, and the method ends, as shown at steps 506 and 508.

Referring again to FIG. 2, after the system has formatted the selected series of frames into a compilation, the system 100 next stores in its memory an association between an image of the compilation and the video containing the frames appearing in the compilation, as shown at step 210. In this exemplary embodiment, this is performed by the video retrieval engine 160. The stored association may involve storing a link to or identification of the video in the memory in association with an image of the compilation. In this case, when a compilation is received from a user, the image of the compilation can be compared to stored compilation images in the system 100 by the system 100 to identify a match, e.g., using image processing software and known image comparison techniques. Alternatively, the stored association may involve storage of copy of data extracted from the visual marker, or data representative or corresponding to the image of the compilation. In this case, when a compilation (or data) is received from a user, the matching video is found by using frame image data and visual markers to match the video clip, e.g., using well-known ML/CBIR (content-based image retrieval) techniques. It should be noted that any suitable technique may be used to identify or characterize the compilation by photographing/scanning/imaging it with a user's computing device.

At this point, the pictorial compilation has been created and may be printed in a photobook. In certain embodiments, the information for printing the compilation may be transmitted by the IPS to another system, e.g. for manipulation and integration into a photobook, and for printing of the photobook. In this example, the IPS 100 includes a photobook creation engine 170. The photobook creation engine can be, or provide functionality, identical to, or substantially to, conventional photobook creation software/websites. Accordingly, for example, the photobook creation engine 170 may provide a user interface allowing a user to browse digital images (e.g., still images) and select and arrange them into one or more templates or otherwise create a photobook. Consistent with the present invention, the photobook creation engine provides an interface whereby the user can select the compilation and/or otherwise ensure that it is included in the photobook, for example, in association with an image from the video, or other images. The interface may allow “drag and drop” or other functionality for placing the compilation within the photobook.

Referring again to FIG. 2, the system next transmits to a printing facility 40 instructions to print a photobook including the compilation, as shown at 212. In this example, these instructions may also include instructions to print a variety of still images, titles, captions, etc. as is conventional with respect to printed photobooks. By way of example, these instructions may be transmitted from the IPS 100 via the communications network 30 to the printing facility 40, e.g., using conventional hardware and software known in the field of computer networking.

Referring now to FIGS. 7A and 7B, this may result in the printing at the printing facility 40 of a photobook 80 including the compilation, e.g. compilation 66 shown on page 82 of FIG. 7B. In certain embodiments, the compilation is disposed in juxtaposed or overlapping relationship to a still digital photograph, particular one include the same or related subject matter and/or extracted from the same video from which the frames in the compilation were extracted.

Optionally, the system may be configured to display an electronic version of the photobook to the user, for example, by transmitting data via the communications network to a user's computing device, such as PC 20c or smartphone 20d, e.g., for display via a web browser of the user's computing device. The compilation may be displayed in “mock-up” form to represent an actual photobook, etc., and thus may allow a user to navigate the book interactively to view, for example, each page of the photobook.

Referring again to FIG. 2, the exemplary IPS 100 also serves the function of receiving user's requests for videos associated with compilations printed n photobooks, and for serving video content in response to those requests. It should be noted that in alternative embodiments, these functions may be performed by separate systems and/or the videos may be stored and/or served by other external systems. In this exemplary embodiment, the IPS 100 monitors for a communication from a user's computing device, e.g., 20c-20e received by the IPS 100 via the communications network 30. The communication includes data representative of at least a portion of the pictorial compilation, as shown at step 214. Any suitable data may be contained in the request, and will depend upon the configuration of the system. In essence, the communication includes enough data gathered from photographing/imaging/capturing the compilation to permit identification of the compilation, so that an associated video can be identified. By way of example, the communication may include a photographic image of the compilation. By way of further example, some pre-processing may be performed at the device/smartphone, such as compilation boundary detection and alignment (i.e. cropping and re-scaling). Optionally, visual feature detection and classification may also be performed at the device.

In response to receipt of such a communication containing such data, the system 100 then references its memory 118 to identify a video associated with the corresponding compilation, as shown at step 216. By way of example, this may be performed by the video retrieval engine 160, and may involve comparison of the image of the compilation with images of stored compilations and/or comparison of data representing the image of the compilation with data representing images of stored compilations. Visual markers may also be analyzed and/or classified at this stage to aid with overall matching accuracy.

After the system identifies the compilation, the system identifies the associated video content/file, e.g., by referencing the data stored in the memory of the system 100 in step 210. Subsequently, in this embodiment, the IPS 100 then retrieves the associated video corresponding to the compilation, and transmits the identified video to the user's computing device, e.g., via a network, as shown at step 218, and the method ends, as shown at 220. It should be appreciated that in alternative embodiments, the IPS 100 may instead transmit a link to the associated video, so that a user may use his/her computing device to follow the link and download/view the associated video.

Accordingly, in use, a user may use conventional computing devices such as 20a-20e to capture digital images such as digital photographs and digital videos. Similarly, the user may upload these still images and videos to a photobook creation website in a conventional manner. Any videos received by the IPS 100, either by direct uploading by a user, or indirectly in a scenario in which the IPS 100 servers as a “back end” for a separate photobook creation website or system, can be processed in as described above to cause creation of a corresponding pictorial compilation. The still images and the pictorial compilation may then be manipulated by the user via a graphical user interface to create an electronic version of a photobook, e.g., via a substantially conventional photobook creation website/interface. Unlike conventional photobook creation websites/interfaces, the user is permitted to include in the photobook the pictorial compilation created by the IPS 100. When included in the photobook, the pictorial compilation serves as a link for download/retrieval/viewing of associated video content.

Further, a user browsing a photobook including a compilation may follow the link to download/retrieve/view video content associated with a compilation printed in the photobook by using the camera functionality of the user's camera-based computing system (such as smartphone/tablet computer 20d) to focus on and capture an image of the compilation, as shown in FIG. 8. After doing so, the user may send the photo to the IPS directly (e.g., via email or text), or indirectly (e.g., by using a compatible software application configured to automatedly send captured images to the IPS). Alternatively, a software application operable on the client device may be specially-configured to upload the images directly to the IPS. In response, the IPS 100 identifies the compilation, identifies the associated video content, and transmits data to the requesting smartphone/tablet computer 20d, which in turn displays the corresponding video 90 via its display device, as shown in FIG. 9. In this manner, the content of the photobook, namely still photographic images, is supplement by rich, context-relevant audiovisual content by way of display of the associated video, so that the still images of the photobook can be viewed in conjunction with the dynamic video images displayed via the computing device 20d, effectively, “bringing to life” the static images of the photobook.

FIG. 10 is a schematic diagram showing an exemplary image processing system (IPS) 100 in accordance with an exemplary embodiment of the present invention. The IPS 100 is shown logically in FIG. 1 a single representative server for simplicity of illustration only. The IPS 100 includes conventional server hardware storing and executing specially-configured computer software collectively providing a novel special-purpose computer system for carrying out methods in accordance with the present invention. Accordingly, the exemplary IPS 100 of FIG. 10 includes a general purpose microprocessor (CPU) 102 and a bus 104 employed to connect and enable communication between the microprocessor 102 and the components of the IPS 100 in accordance with known techniques. The exemplary IPS 100 includes a user interface adapter 106, which connects the microprocessor 102 via the bus 104 to one or more interface devices, such as a keyboard 108, mouse 110, and/or other interface devices 112, which can be any user interface device, such as a touch sensitive screen, digitized entry pad, etc. The bus 104 also connects a display device 114, such as an LCD screen or monitor, to the microprocessor 102 via a display adapter 116. The bus 104 also connects the microprocessor 102 to memory 118, which can include a hard drive, diskette drive, tape drive, etc.

The IPS 100 may communicate with other computers or networks of computers, for example via a communications channel, network card or modem 122. The IPS 100 may be associated with such other computers in a local area network (LAN) or a wide area network (WAN), and may operate as a server in a client/server arrangement with another computer, etc. Such configurations, as well as the appropriate communications hardware and software, are known in the art.

The IPS is specially configured in accordance with the present invention. Accordingly, in the example of FIG. 10, the IPS 100 includes computer-readable, microprocessor-executable instructions stored in the memory 118 for carrying out the methods described herein. Further, the memory stores certain data, e.g. in databases or other data stores shown logically in FIG. 10 for illustrative purposes, without regard to any particular embodiment in one or more hardware or software components. For example, FIG. 10 shows schematically storage in the memory 118 of web server software 120, video processing engine 180 instructions/software including frame extraction engine 140 instructions for selecting and/or capturing and/or extracting a set of still images from a video being processed by the IPS 100, compilation creation engine 150 software/instructions for creating a pictorial compilation including the still images extracted from the video, and video retrieval engine 160 software/instructions allowing for recognition of a compilation and/or receipt of information identifying a compilation, and subsequently identifying the video associated with the compilation and causing the associated video to be retrieved from video storage 130 and transmitted to a user, in response to the user's scanning/imaging/capturing of the pictorial compilation with the user's computing device, e.g., as displayed in a printed photobook. FIG. 10 also shows schematically storage in the memory 118 of photobook creation engine 170 software/instructions for providing a graphical user interface via which a user may review digital images and design a photobook.

Additionally, computer readable media storing computer readable code for carrying out the method steps identified above is provided. The computer readable media stores code for carrying out subprocesses for carrying out the methods described above.

A computer program product recorded on a computer readable medium for carrying out the method steps identified above is provided. The computer program product comprises computer readable means for carrying out the methods described above.

In the exemplary embodiment described above, images are uploaded to a central system, and certain processing is performed at the central system. It should be noted, however, that in alternative embodiments one or more of the steps described as occurring at the central system may alternatively be performed at the client device.

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

1. An image processing system comprising:
a processor;
a memory operatively connected to the processor for data communication therewith;
instructions stored in the memory and executable by the processor to provide a communications engine for transmitting data via a communications network;
instructions stored in the memory and executable by the processor to provide a video processing engine configured for capturing a set of still images from a video;
instructions stored in the memory and executable by the processor to provide a compilation creation engine configured for creating a pictorial compilation including the set of still images extracted from the video; and
instructions stored in the memory and executable by the processor to provide a video retrieval engine configured for identifying a pictorial compilation, identifying a corresponding video associated with the pictorial compilation, and causing the corresponding video to be transmitted to a user, in response to the user's imaging of the pictorial compilation with the user's computerized imaging device.

2. A computer-implemented method for creating a video-linked photobook, the method comprising:
providing a microprocessor-driven image processing system comprising a video processing engine;
receiving at the image processing system a video file including video content;
the video processing engine processing the video file to identify a series of still image frames extracted from the video content;
the video processing engine formatting the series of still image frames into a pictorial compilation;
storing in a memory the pictorial compilation, and an association between the pictorial compilation and the video file; and
transmitting from the image processing system computer-readable instructions for printing the pictorial compilation.

3. The method of claim 2, wherein said transmitting comprises transmitting instructions for printing a photobook including the pictorial compilation.

4. The method of claim 3, wherein said transmitting comprises transmitting said instructions to a printing facility capable of printing the photobook.

5. The method of claim 2, further comprising monitoring for a communication from an electronic computing device that includes data representative of at least a portion of the printed compilation.

6. The method of claim 5, wherein said monitoring is performed by a computing system.

7. The method of claim 5, wherein said monitoring is performed by said image processing system.

8. The method of claim 5, wherein said data comprising data representative of at least a portion of the printed compilation comprises an electronic image file produced by imaging said pictorial compilation with a digital camera.

9. The method of claim 7, further comprising:
in response to receipt of said data, said video processing engine referencing its memory to identify a corresponding video file associated with said data.

10. The method of claim 9, wherein said referencing its memory to identify a corresponding video file associated with said data comprises:
the video processing engine comparing said data representative of at least a portion of the printed compilation to said pictorial compilation stored in the memory; and if said data representative of at least a portion of the printed compilation corresponds to said pictorial compilation stored in the memory, then the video processing engine identifying the corresponding video file as that video file for which the printed compilation has a stored association.

11. The method of claim 7, further comprising:
transmitting the corresponding video file via a communications network.

12. The method of claim 11, wherein said data is received from a computing device, and wherein said transmitting comprises transmitting the corresponding video file to the computing device.

13. The method of claim 2, wherein said processing the video file to identify a series of still image frames extracted from the video content comprises:
the video processing engine processing the video file to identify a time length for the video;
the video processing engine identifying a number desired frames for the series;
the video processing engine dividing the time length into a plurality of time segments as a function of the number of desired frames; and
the video processing engine extracting a plurality of still image frames from the video file, each extracted still image frame corresponding to a beginning and/or an end of each time segment.

14. The method of claim 13, wherein said number of desired frames is identified by input provided by a user.

15. The method of claim 13, wherein said number of desired frames is identified by retrieval of a setting from the memory.

16. The method of claim 2, wherein said processing the video file to identify a series of still image frames extracted from the video content comprises:
the video processing engine processing the video file to identify a plurality of frames;
the video processing engine performing image processing analysis on each of the plurality of frames;
the video processing engine identifying a frame selection methodology for identifying frames of interest;
the video processing engine identifying frames of interest in accordance with the frame selection methodology, the frames of interest being the still image frames.

17. The method of claim 2, wherein said formatting the series of still image frames into the pictorial compilation comprises:
the video processing engine identifying a visual marker usable for identification of a compilation; and
the video processing engine creating the pictorial compilation to include the series of still image frames and the visual marker.

18. The method of claim 17, wherein said visual marker is predetermined and stored in the memory of the image processing system.

19. The method of claim 17, wherein said creating the pictorial compilation to include the series of still image frames and the visual marker comprises arrangement the series of still image frames within the pictorial compilation in a sequence corresponding to the time-order sequence of occurrence with the video file.

20. The method of claim 2, further comprising:
printing a physical object, the physical object including the pictorial compilation in printed form.
